(19) United States
(12) Patent Application Publication
(10) Pub. No.: US 2026/0260040 A1
(43) Pub. Date: Sep. 3, 2026

(54) AUTOMATED OPTIMIZATION OF SOLDER PASTE OVERPRINTS USING PHYSICS-BASED SIMULATION

(71) Applicant: Nvidia Corporation, Santa Clara, CA (US)

(72) Inventors: Xiaoxuan Cui, Shenzhen City (CN); Yanchen Wang, Shanghai City (CN); Ziyi Chen, Shenzhen City (CN); Yamin Wang, Shenzen City (CN); Xijiang Bian; Tao Zhang, Shenzen City (CN)

(21) Appl. No.: 19/068,903

(22) Filed: Mar. 3, 2025

(51) Int. Cl. G06F 30/27; G06F 111/10

(52) U.S. Cl. CPC G06F 30/27; G06F 2111/10

(57) ABSTRACT

Approaches are described for optimizing solder paste overprint distribution on printed circuit boards (PCBs) using virtual representations within a physics-based simulation environment integrated with cloud-based infrastructure. Solder paste overprint representations may be initialized to correspond to pins and holes in the PCB layout. These virtual representations may expand dynamically in all directions, guided by predefined constraints such as pin boundary limits, collision handling, minimum spacing requirements, and maximum penetration depth to control overlap between neighboring regions. The simulation may iteratively evaluate interactions between expanding regions and apply directional and penetration constraints to maintain separation and prevent interference. Each representation may be assessed for target area completion based on spatial and design conditions. Optimized output data, including final overprint dimensions and positions, may be generated and stored in a cloud-based system for integration with PCB design tools and remote access for further layout refinement and manufacturing preparation.

### BACKGROUND

In printed circuit board (PCB) manufacturing, reliable electrical connections are essential. Through-hole soldering, where component pins are inserted into drilled holes and secured with solder, is a common method. Traditionally, this was done using wave soldering, which involves applying molten solder across the entire board. A more modern approach, Paste-In-Hole (PIH) soldering, deposits solder paste directly into holes before inserting components. The paste melts during reflow and bonds the pins to the board. For PIH to work properly, precise overprints—the areas where solder paste is applied—must be designed to account for factors like hole and pin sizes, PCB thickness, and paste flow behavior. Designing these overprints is complicated by issues such as paste shrinkage during reflow, varying board thicknesses, and spacing constraints on densely packed boards. Engineers currently rely on formulas to manually calculate and draw overprints such that the paste volume and distribution meet industry standards. This manual process is time-consuming, error-prone, and difficult to optimize, especially when multiple board configurations are needed.

### BRIEF DESCRIPTION OF THE DRAWINGS

Various embodiments in accordance with the present disclosure will be described with reference to the drawings, in which:

FIG. 1A illustrates an example top view of a PCB, according to at least one embodiment;

FIG. 1B illustrates an example cross-section view of an example PIH, according to at least one embodiment;

FIG. 1C illustrates an example overprint layout, including an arrangement of multiple pins and their corresponding overprint areas, according to at least one embodiment;

FIG. 1D illustrates an example simulation process with virtual representations for simulating a solder paste optimization process, according to at least one embodiment;

FIG. 1E illustrates an example optimized overprint design generated by a simulation process, according to at least one embodiment;

FIGS. 2A to 2C illustrate an example simulation-based process designed to optimize solder paste overprint areas on a PCB, according to at least one embodiment;

FIG. 3A illustrates an example cloud-based system for optimization of solder paste overprint areas on PCBs, according to at least one embodiment;

FIG. 3B illustrates an example comparison of time efficiency between different approaches for optimizing solder paste overprint areas in PCB design, according to at least one embodiment;

FIG. 4 illustrates an example process flow for optimizing solder paste overprint areas using a simulation-based approach, according to at least one embodiment;

FIG. 5 illustrates a flowchart depicting an example process for optimizing solder paste overprint areas, according to at least one embodiment;

FIG. 6 illustrates an example system, including a hardware design optimization system, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and unpiloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), multi-modal language models, etc., systems for performing generative AI operations (e.g., using one or more language models, transformer models, etc.), systems for performing light transport simulation, systems for performing collaborative content creation for 3D assets, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Approaches in accordance with embodiments of the present disclosure address the challenges associated with designing and optimizing solder paste overprint areas for through-hole components in the manufacturing printed circuit board (PCB) and other electronic substrates. Disclosed embodiments may utilize a physics-based simulation to automate the generation of overprints for efficient, accurate, and optimized designs that adhere to physical and manufacturing constraints without requiring manual calculations.

In PCB assembly, Paste-In-Hole (PIH) soldering may involve depositing solder paste into through-holes, followed by inserting component pins. During the reflow process, the solder paste melts and bonds the pins to the conductive layers of the board. A critical component in this process is the overprint, which defines the area where solder paste is applied around and within each hole to ensure proper solder flow and connection. The solder paste may be applied through stencil openings, which are openings in a stencil sheet placed on top of the board. The stencil may guide the paste to predefined locations on the board and ensure that a controlled amount of paste is deposited.

Approaches described herein address the challenge associated with optimizing the distribution of solder paste overprints for stencil openings. Unlike manual calculations that rely on predefined formulas, which may be time-consuming and error-prone, embodiments in accordance with the disclosed approaches may utilize a physics-based simulation to achieve a more efficient and accurate optimized solution. In disclosed approaches, each PIH pin may be represented within a virtual physics simulation by a corresponding three-dimensional element (such as a block or a cube) modeling the overprint area. These simulation blocks may be initialized based on the positions of the pins or design documents and expand uniformly in multiple directions under defined physical parameters. The expansion of these simulation blocks is dynamically governed by physics constraints. These include properties such as collision responses, force interactions, and defined growth limits in proximity to pin boundaries and neighboring overprints.

The simulation of the expansion may be governed by constraints such as proximity to the pin boundary and neighboring overprints. If a simulation block reaches a boundary or collides with another, its growth in that direction may be ceased but may continue in other directions. The simulation may enforce multiple constraints to ensure compliance with manufacturing standards. The constraints may include maximum and minimum distances between pins and board edges (e.g., a maximum of 5 millimeters and a minimum of 0 millimeters) and a minimum clearance (e.g., 0.25 millimeters) between adjacent overprints. Expansion concludes when all simulation blocks reach their optimal size such that solder paste is properly distributed without overflow or gaps.

In one embodiment, the simulation process may progress in iterative intervals, continuously evaluating the size and positioning of each simulation block. A block is marked as complete and ceases further growth once it reaches its target size, which is defined by parameters such as the through-hole volume, pin volume, and required solder paste coverage. If further growth is obstructed by physical or boundary constraints—such as proximity to other blocks or predefined design limits—the block is also marked complete. The simulation continues this evaluation and adjustment cycle until all blocks achieve an optimized layout that satisfies both physical and manufacturing constraints.

Disclosed embodiments may further integrate a cloud-based architecture. Input parameters, such as board thickness, pin dimensions, symbols, and component positions, are processed and stored in a centralized library of pre-calculated overprint configurations. Users may access these optimized designs through a cloud-based PCB design tool, which enables rapid and efficient overprint generation within seconds. Such an architecture may further reduce the computational burden on local resources and eliminate the need for repeated manual recalculations across varying board configurations.

Embodiments in accordance with the present disclosure may provide several technical advantages. For example, one technical advantage lies in the automation of solder paste overprint generation through a physics-based simulation. In traditional PCB manufacturing, engineers normally manually design overprints for each through-hole component. This process involves applying mathematical formulas to calculate the necessary solder paste volume, then adjusting and redrawing overprint shapes to meet various physical and manufacturing constraints, such as spacing between components and stencil opening sizes. This manual approach is labor-intensive. For each variation in board thickness, engineers may need to create multiple versions of the overprint designs, which can take several hours per component. In environments where PCB designs include numerous components and thickness variations, this quickly scales to days or even weeks of work. Moreover, manual calculations and shape adjustments are prone to errors, such as underestimating or overestimating the overprint size, which can result in defects during manufacturing. Errors like insufficient solder paste may lead to weak or unreliable solder joints, while excessive paste can cause overflow, electrical shorts, or bridging between adjacent pins. Disclosed embodiments may automate this entire process by simulating the expansion of overprint areas through a physics-based simulation approach by modeling each overprint area as a virtual three-dimensional element. Each overprint area may be modeled as a dynamically expanding simulation block, initialized based on input parameters such as pin location, hole size, and component footprint. The simulation may automatically achieve a globally optimized solution by employing physics-based constraints to control the block's growth behavior, such as collision detection, which prevents blocks from expanding beyond defined boundaries, and mutual forces that ensure blocks push and balance each other to achieve equitable growth. Such a process may allow all overprint shapes to automatically evolve simultaneously while optimizing for global distribution under space and manufacturing constraints.

Additionally, disclosed approaches make the overprint design process more adaptable and allow engineers to handle different design needs and constraints with ease. Unlike traditional methods that involve manual calculations for each overprint, such an approach uses a simulation to model each overprint area as a block controlled by physics-based rules. The simulation accounts for real-world factors like collisions, friction, and boundary limits, making design optimization more efficient and flexible. Various parameters may be adjusted—such as material friction, mass, collision offset (e.g., 0.25 mm), max de-penetration velocity, and expansion speed—to fit various design scenarios. These include changes in PCB thickness, pin size, component layout, and spacing tolerances. This flexibility allows engineers to quickly test and fine-tune multiple configurations to save time and reduce errors.

Furthermore, embodiments may leverage a cloud-based architecture to provide scalability and accessibility. Input parameters such as component dimensions and board thicknesses are processed and stored in a centralized library of pre-generated configurations. By allowing users to access these optimized designs through PCB design tools, the architecture minimizes the need for local computation and manual recalculations. Such an architecture improves workflow efficiency, particularly for large-scale manufacturing environments where different board configurations and design iterations are common. The cloud integration may also ensure that design data is consistent and readily available for a faster deployment of new product designs without delays in the manufacturing process.

Variations of this and other such functionality can be used as well within the scope of the various embodiments as would be apparent to one of ordinary skill in the art in light of the teachings and suggestions contained herein.

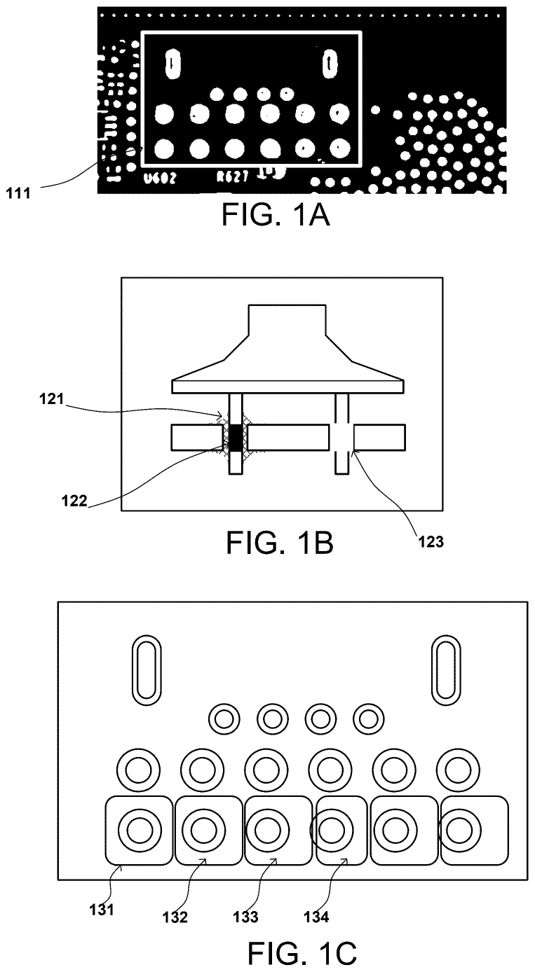

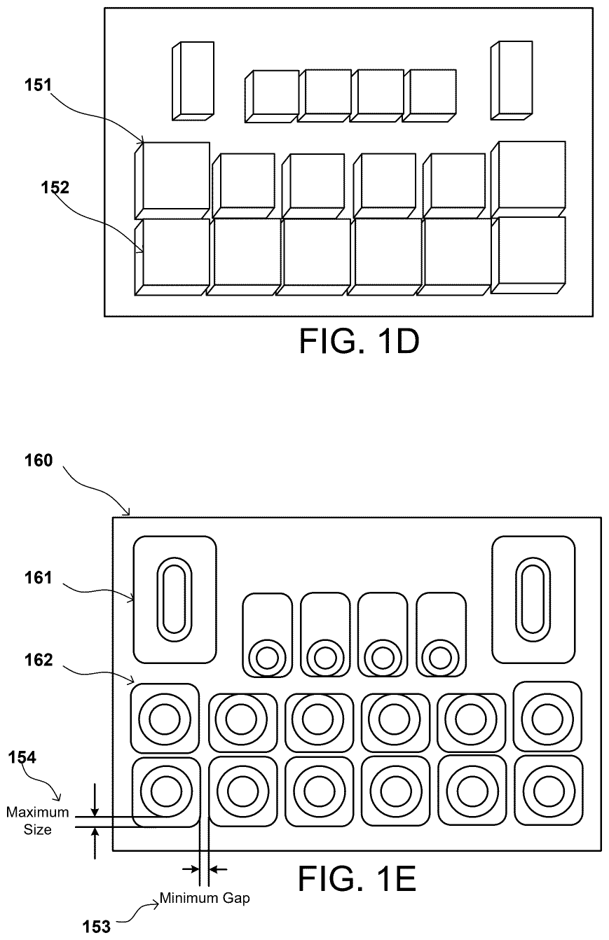

FIGS. 1A-1C show three example illustrations that depict the layout and configuration of a printed circuit board (PCB) and the components involved in the paste-in-hole (PIH) soldering process, which may present challenges in achieving balanced solder paste overprint distribution when calculated manually. FIG. 1A shows a top view of a PCB section, where highlighted section 111 may include multiple pins arranged in a dense pattern. Each pin may serve as a connection point for electronic components soldered onto the board using through-hole technology. In this process, pins may be inserted into holes drilled into the PCB, and solder paste may be applied around the pins to secure the electrical and mechanical connection after reflow soldering.

FIG. 1B is an example cross-section illustration that provides a side view of a PIH structure, where a pin may pass through a hole in the PCB. Area 121, which is shaded with crossed lines, may refer to solder paste volume which represents the amount of solder paste initially applied to surround the pin within the hole. Region 122 may indicate the physical space occupied by the pin inside the hole. The size and shape of the pin may vary depending on the component design, and this volume reduces the available space for solder paste within the hole. The remaining volume to be filled by solder paste, referred to as the hole volume 123, represents the total volume that needs to be filled by solder paste after accounting for the pin's presence. It may be calculated by subtracting the pin volume from the total hole volume. To ensure a proper solder joint, the stencil opening used during the paste application process may be designed to match the required solder paste volume. The paste applied through the stencil must melt and flow to completely fill the remaining hole volume during reflow without leaving voids or causing overflow. The overprint area surrounding each pin extends beyond the hole and may play an important role in solder coverage. Overprints are designed to account for paste spreading and contraction during the soldering process, which need to be precisely calculated to achieve a balance between coverage and clearance. Insufficient solder paste may result in weak joints, compromising the mechanical integrity and conductivity of the connection. Conversely, excessive solder paste may lead to solder overflow, which can cause defects such as bridging between adjacent pins or components. This can result in electrical shorts or other malfunctions in the circuit.

FIG. 1C is an example overprint layout illustration that may present a schematic arrangement of multiple pins and their corresponding overprint areas. Each overprint area may be defined to maximize solder flow while maintaining a specified gap from other pins and components. However, manual methods for determining these overprint areas may encounter difficulties, particularly in high-density designs where available space is limited. For example, enlarging the overprint for one pin may reduce the space for neighboring pins, resulting in inconsistent coverage across the board. The example overprint layout illustration in FIG. 1C shows multiple pins, labeled with overprint areas 131, 132, 133, and 134, and illustrates how overprint size can influence neighboring areas. When manually designing these overprints, assigning a maximized size for one overprint, such as overprint area 132, may affect the available space for adjacent areas like overprint area 133. This competition for space may result in imbalances across the layout, with some pins receiving excessive solder paste and others insufficient amounts, which may lead to potential manufacturing defects such as solder bridging or incomplete joints.

FIGS. 1D and 1E are example illustrations of an automated approach to optimizing solder paste overprints on a printed circuit board (PCB). For illustration purposes, such a PCB may be the same section 111 of the PCB from FIG. 1A, which includes multiple pins arranged in a dense formation. As previously described, each pin serves as a connection point for electronic components that are inserted through holes and soldered into place. The densely packed nature of these pins introduces design challenges in balancing solder paste overprint areas, which is addressed through simulation in this embodiment.

FIG. 1D may depict an example simulation process that illustrates a modeled representation of the solder paste optimization process. Here, each pin in the target section may be associated with a simulation block, such as simulation block 151, which represents a virtual element that can grow dynamically in the simulation to simulate the expansion of solder paste around the pin. For example, a simulation block corresponding to a specific pin may start as a small block centered around the pin's position. The block may expand outward evenly in all directions according to pre-configured parameters such as expansion velocity, material friction, max de-penetration, and collision detection. As each block expands, it may encounter physical constraints such as pin boundaries and adjacent blocks. For example, if a block reaches the edge of the pin, further expansion in that direction may be halted. When two blocks, such as those representing pins positioned side by side, collide during expansion, mutual forces may be applied. The simulation may cause both blocks to stop expanding in the collision direction while still allowing further growth in unconstrained directions. For example, if block 151 of one pin collides with block 152 of a neighboring pin, such a simulation process may prevent overlap to ensure sufficient spacing between solder paste regions.

Parameters such as the minimum allowable gap 153 (e.g., 0.25 mm) and maximum overprint size 154 (e.g., 5 mm from the pin boundary) may also influence the final shape of each simulation block. These constraints ensure that each block achieves a balance between maximizing solder coverage and avoiding defects such as solder bridging or insufficient solder. For example, FIG. 1E may illustrate an overprint design 160 that depicts the layout resulting from the simulation process. Overprint areas, such as overprint area 161, may correspond to the optimized regions of solder paste surrounding each pin. Each area may have been adjusted to fit within the available space while maintaining the necessary clearance from neighboring pins and components. For example, if overprint area 162 had limited room for expansion due to the presence of adjacent pins, it may be proportionally smaller than overprint area 161, but still within acceptable manufacturing tolerances. By dynamically modeling the expansion of solder paste in parallel across the entire PCB, such a simulation process may efficiently reach optimized designs that are difficult to achieve through manual calculations.

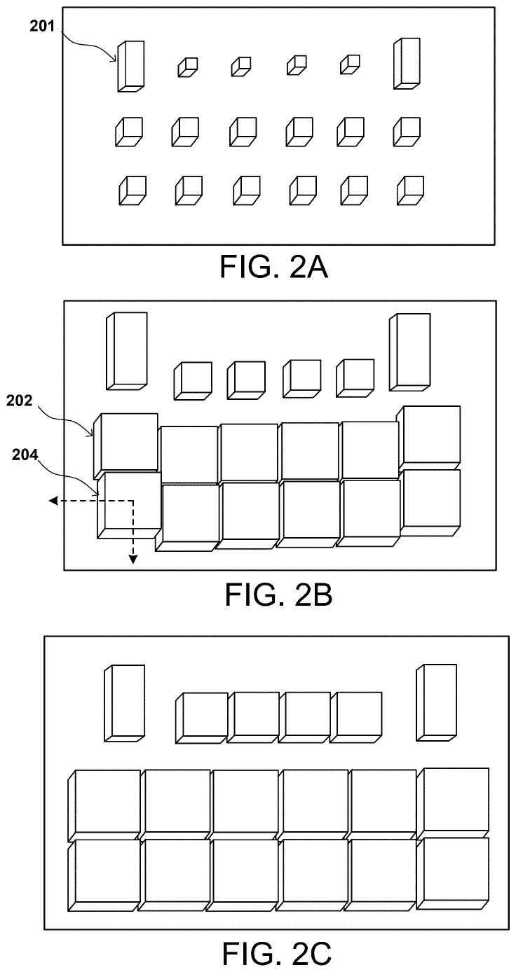

FIGS. 2A to 2C illustrate an example simulation-based process designed to optimize solder paste overprint areas on a printed circuit board (PCB). Such a process may involve initializing, expanding, and stabilizing simulation blocks that model the physical behavior of solder paste under various constraints.

In FIG. 2A, each simulation block 201 may be initialized at coordinates corresponding to a pin's position on the PCB. These blocks represent the initial solder paste simulations based on factors such as pin geometry, hole dimensions, and expected solder volume. The simulation process uses physics-based parameters—including max de-penetration, expansion velocity, collision offsets, and material resistance—to control how the blocks expand and interact during growth. These parameters may be tuned to achieve stable simulation results. These parameters govern the physical behavior of solder paste expansion, including how quickly it spreads and how it interacts with other overprint regions. For example, expansion velocity governs the speed of outward growth, while collision offsets create buffer zones to prevent premature contact between blocks. If the expansion velocity is set too high, the simulation may not accurately detect collisions in time, causing blocks to overlap and create unintended design defects. Conversely, if the expansion is too slow, the simulation may become inefficient, requiring excessive time to complete optimization. As used herein, max de-penetration velocity may control how rapidly overlapping regions are separated and adjusting the max de-penetration velocity may prevent instability or unrealistic behavior caused by abrupt separations during the simulation process.

Similarly, inappropriate collision offset settings can lead to design errors. If the offset is too small, blocks may come into direct contact, resulting in insufficient spacing between solder paste areas and increasing the risk of electrical shorts. On the other hand, if the offset is too large, excessive gaps may form, leading to under-utilized board space and weaker mechanical stability. Material friction parameters also influence how smoothly or aggressively blocks expand; low friction settings may allow for uncontrolled growth, while high friction settings could overly restrict expansion and prevent some regions from reaching the required target area.

FIG. 2B illustrates an intermediate stage where the simulation blocks have expanded and are now interacting with various constraints. Growth in a specific direction may be restricted if a block reaches a spatial limit, such as a pin boundary or a maximum allowable distance from the pin (which may, for example, be set between 3 mm and 5 mm). In such cases, a directional constraint may be applied to prevent further expansion along that axis. In one embodiment, two constraint properties may be defined, such as “CANNOT_GO<Direction>” and “BLOCKED_ON<Direction>”. These properties may control the growth of each block when collisions or spatial limits occur. A “CANNOT_GO<Direction>” property may clarify that a block can no longer move or expand in a specific direction because it has reached a hard limit, such as the edge of a solder pad or pin boundary. For example, if a block's left side reaches 0 mm from the boundary of a pin, such a simulation process may set the “CANNOT_GO<LEFT>” property to True to prohibit further growth to the left. Once this property is applied, the block becomes a permanent barrier to any neighboring block attempting to grow into that region. On the other hand, the “BLOCKED_ON<Direction>” property may indicate that a block's expansion is temporarily halted due to a collision with another block that has reached its limit. This occurs when a block collides with a neighboring block that already has a “CANNOT_GO<Direction>” property set.

As such, such a simulation process may be governed by a set of mutual forces that allow the blocks to collide, push, and influence each other under physical simulation rules. Each block's growth may temporarily continue after a collision, as the application of directional constraints such as “CANNOT_GO<Direction>” or “BLOCKED_ON<Direction>” depends on the state of neighboring blocks. For example, if a block encounters another block (or may be referred to as the “colliding block”) that already has the “CANNOT_GO<Direction>” constraint set, the block initiating the collision will adopt a corresponding constraint to halt its growth along that direction. However, if the colliding block does not yet have the “CANNOT_GO<Direction>” property set, both blocks may continue exerting mutual forces and striving to expand until a constraint condition is reached by either the colliding block or another block in its expansion chain. In this situation, the simulation enforces a chain reaction of constraints, whereby the directional limitation propagates from block to block. For example, if a neighboring block reaches the boundary of a solder pad or a predefined clearance limit (e.g., 5 mm from the pin boundary), the “CANNOT_GO<Direction>” property may be triggered for that block, and subsequently for all blocks colliding in that direction.

Such a simulation process may include dynamic constraint propagation between colliding blocks. For example, if a first block has a “CANNOT_GO<LEFT>” property and a second block collides with the first block's right edge, the second block will inherit a “BLOCKED_ON<LEFT>” property and halt its growth to the left. As a result, the second block becomes a new limiting barrier for subsequent blocks (e.g., a third block), continuing the constraint propagation in a structured manner.

These constraints, which define minimum gaps and maximum distances between features, are primarily guided by manufacturing requirements to prevent issues like electrical shorts or insufficient bonding. At the same time, physics-based simulation parameters—such as max de-penetration velocity, expansion velocity, collision offset, and material resistance—ensure stable and realistic growth behavior during the simulation. These parameters help maintain proper interactions between blocks, controlling how they push against or collide with one another, thereby achieving a globally optimized layout without compromising manufacturing standards. This combination of physics-driven modeling and manufacturing constraints supports the creation of layouts that are both optimal for performance and compliant with production requirements.

Interactions between neighboring blocks may trigger collision handling mechanisms. For example, if block 202 collides with block 204, the simulation may apply mutual constraints. For example, if block 204 is already restricted on one side, that restriction may propagate to block 202, halting growth in the collision direction. Despite these limitations, blocks may still exert forces on each other, redistributing available space dynamically. This ensures that each block continues to optimize its area without compromising spacing requirements. The simulation may enforce a minimum gap between blocks, which may be set to 0.25 mm or another value depending on the design specifications. At regular time intervals, the simulation may evaluate the status of each block. A block may be marked as Completed if it reaches a target area defined by an optimization formula (such as one based on pin size and PCB thickness). If a block becomes fully constrained in all directions before reaching the goal area, it may also be marked as Completed to prevent further processing.

FIG. 2C shows the final stage of the simulation, where all blocks have reached their stabilized states. In FIG. 2C, the blocks have stabilized, each achieving a final expanded state within the defined constraints. For example, a block may be determined to have reached the optimal overprint area based on its location and surrounding conditions. The simulation may periodically check each block's status at regular intervals defined by a unit of time (e.g., Delta_Time). If a block's size reaches the predefined goal area, such a system may halt its expansion and marks the block's status as “Completed.” Conversely, if a block cannot grow further because its “BLOCKED_ON<Direction>” properties are set for all directions, the block may be also marked as “Completed.” The iterative process continues until all blocks have been marked as “Completed.” The final arrangement may reflect a globally optimized solder paste distribution, where all blocks maintain proper spacing and meet coverage requirements. Such a distribution may be a globally optimized and balanced configuration that maximizes space utilization while adhering to design constraints. The output from the simulation may include block dimensions, coordinates, and spacing data, which can be exported to a PIH overprint data file for integration with PCB design tools.

In alternative implementations, different methods may achieve similar results. Instead of using a physics simulation, some embodiments may employ mathematical solvers that define the expansion process through equations modeling spatial constraints. These solvers may iteratively compute optimal solutions for each block's dimensions. Heuristic methods may also be used, where block growth is adjusted dynamically based on proximity to neighboring blocks or boundaries. Machine learning approaches may offer another option, which may generate initial overprint layouts based on historical PCB designs and refine them through limited simulation.

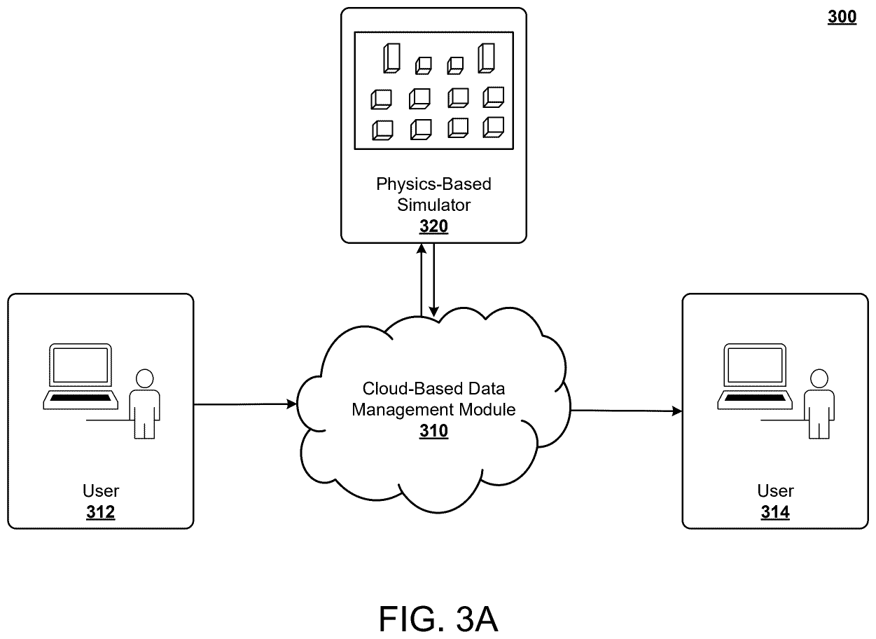

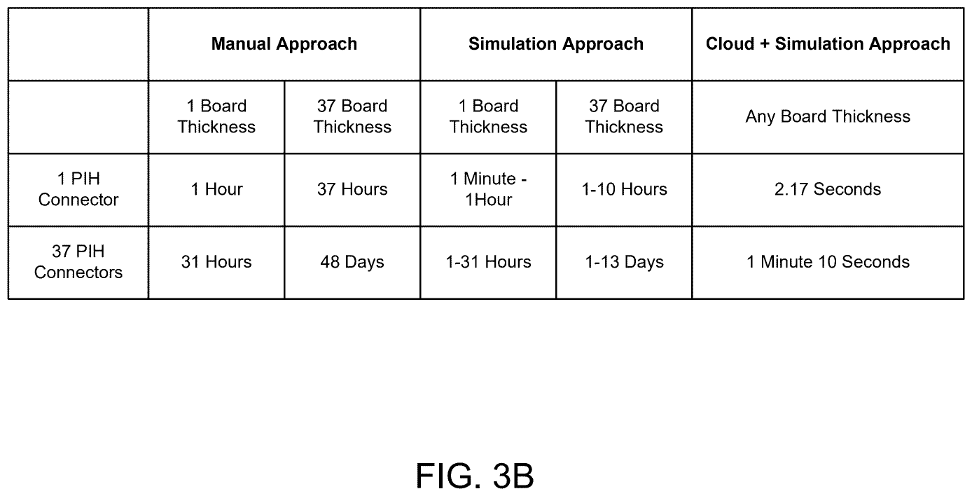

FIG. 3A illustrates an architecture 300 designed to support the optimization of solder paste overprint areas on printed circuit boards (PCBs) using a cloud-based simulation and data management framework. This architecture enables efficient collaboration among multiple users, automated simulation, and the reuse of generated overprint data for different design and manufacturing tasks.

The cloud-based data management module 310 may act as a centralized storage and coordination point for handling simulation data, including PCB layout information, virtual representations of solder paste overprints, and associated parameters such as pin locations and board thicknesses. The cloud-based data management module 310 can store identifiers for each symbol and associated data and allow users to access or update specific design elements. The cloud infrastructure supports version control and ensures that any updates to symbols or design parameters are tracked and made available for other users who need them.

The physics-based simulator module 320 may be responsible for performing simulations that model the behavior of solder paste overprint areas under various conditions. When triggered, the simulator retrieves data from the cloud, including the relevant symbols, their associated physical parameters (e.g., pin dimensions and board thickness), and any predefined constraints such as boundary limits or minimum gap requirements. The simulator may then run the simulations and dynamically expand virtual representations of the solder paste overprint areas according to these parameters, applying physical rules such as collision detection, expansion limits, and penetration constraints. The simulation results, including optimized overprint shapes and dimensions, are sent back to the cloud for storage and further use.

User 312 may represent an example user who may upload new or modified paste-in-hole (PIH) symbols to the cloud library, which can include data on pin geometry, hole sizes, and required stencil openings. When user 312 uploads these symbols, the cloud-based data management module may automatically trigger the physics-based simulator module 320. The simulator processes the new symbols, runs simulations for various board thickness scenarios, and generates corresponding overprint data. Once the simulation is complete, the optimized overprint information, including symbol identifiers and parameter-specific results (e.g., data tailored to a 1.2 mm board versus a 1.8 mm board), is stored in the cloud.

Another user, such as user 314, may need to reuse these generated results without running additional simulations. For example, user 314 might be a layout engineer working on a design that uses the same set of symbols uploaded by user 312. Instead of repeating the entire simulation process, user 314 can query the cloud-based data management module by referencing the relevant symbol identifiers. The cloud then retrieves the optimized overprint data corresponding to the specific board thickness or configuration required. This approach allows user 314 to immediately access validated overprint designs and incorporate them into the PCB layout without manual recalculations or delays.

The architecture also supports further automation by integrating with external design tools. For example, after the cloud updates the overprint data, PCB design tools (e.g., Allegro) may retrieve this information automatically for use in layout editing. In this scenario, the cloud-based data management module may link with a version control system to ensure that updated overprint data is accessible to all relevant applications and users. When a layout engineer selects and/or activates a tool for generating a solder paste overprint (e.g., “Generate Solderpaste Overprint for PIH” tool), the tool can pull the most recent data from the cloud and apply it to the PCB design. This process architecture improves both collaboration and efficiency by reducing redundancy. Users like user 312 can create and update design data, while others like user 314 can quickly access and apply optimized results without re-running simulations. The cloud infrastructure also ensures that all users work with consistent, up-to-date data, minimizing errors and supporting scalable design processes for high-density PCBs.

FIG. 3B illustrates an example comparison of time efficiency between different approaches for optimizing solder paste overprint areas in PCB design. The comparison includes a manual approach, a simulation-based approach, and a cloud-integrated simulation approach. These times are provided as non-limiting examples to demonstrate how automation and cloud-based infrastructure may reduce processing time in a range of design and manufacturing scenarios. In one embodiment, the manual approach may require approximately 1 hour to generate overprint designs for a single PIH connector with one board thickness. For multiple board thicknesses, such as 37 variations commonly encountered in design libraries, this time may increase to 37 hours per connector, and to approximately 48 days when optimizing 37 connectors. By contrast, a simulation-based approach may reduce these times to between 1 minute and 1 hour for a single board thickness. However, when scaling to multiple board thicknesses, processing times may still range from 1 hour to 13 days, depending on the complexity of the design and simulation parameters. In a further example, the cloud-integrated simulation approach provides significant time reductions. The architecture may allow handling of multiple board thicknesses simultaneously, generating overprint data for a single connector in approximately 2.17 seconds. When optimizing 37 connectors across varying thicknesses, the entire process may be completed in approximately 1 minute and 10 seconds. This efficiency gain arises from automated retrieval and reuse of pre-simulated data, eliminating repetitive simulations.

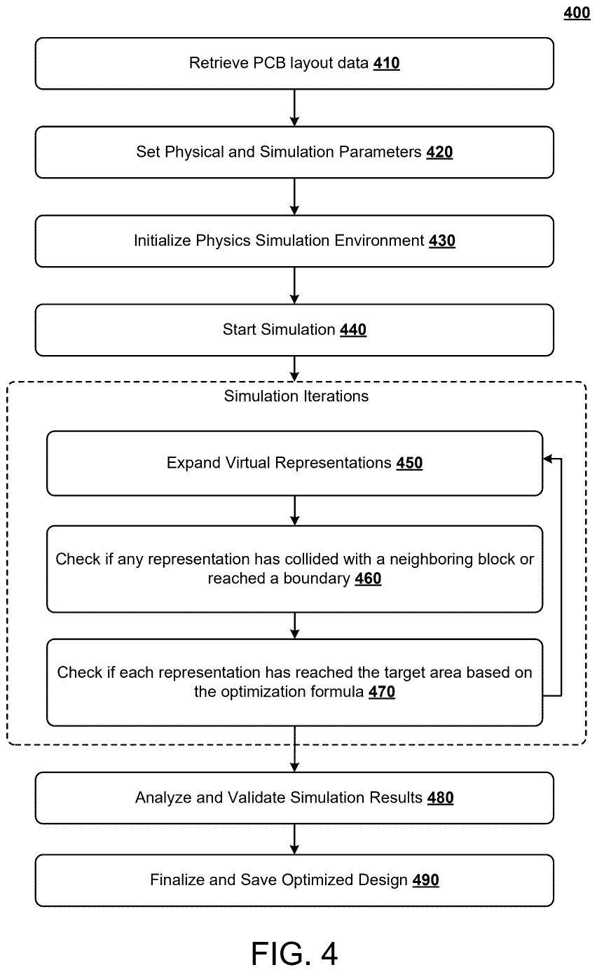

FIG. 4 illustrates an example process flow 400 for optimizing solder paste overprint areas using a simulation-based approach. Process 400 may begin by retrieving 410 the PCB layout data, which may include information about the pin locations, hole sizes, component placement, and predefined design constraints. This data may be obtained from PCB design files or external databases used in electronic hardware design. The retrieved data forms the input for generating virtual representations of solder paste overprint areas.

Physical and simulation parameters may then be defined and assigned 420 to the corresponding virtual representations of solder paste overprint areas. These parameters control the behavior of the virtual simulation and may include factors such as max de-penetration velocity, expansion velocity, material friction, collision offset (e.g., 0.25 mm), and maximum allowable boundary limits. These parameters govern the physical behavior of solder paste expansion, including how quickly it spreads and how it interacts with other overprint regions. Additionally, these settings incorporate key manufacturing constraints such as the minimum required spacing between solder elements and maximum overprint coverage areas to prevent electrical shorts, voids, or other defects. Engineers may customize these values based on the unique requirements of each PCB design and its soldering process.

Based on physical and simulation parameters, a physics simulation environment may be initialized 430. The simulation environment may model real-world conditions such as material behavior, collision responses, and physical interactions between neighboring solder paste regions. Boundary conditions may also be set to constrain growth in specified directions, preventing solder paste from expanding beyond critical regions, such as pin boundaries or adjacent components.

With the constraints and parameters set, a simulation process may start 440. In this step, virtual representations of solder paste overprints may be controlled to expand outward from their initial positions. The simulation may run in cycles or iterations, during which each representation grows according to its assigned parameters. This process may occur in parallel for multiple representations for synchronized growth across the entire PCB layout.

In step 450, the expansion of these virtual representations is continuously monitored. The system dynamically adjusts the behavior of each block based on interactions with neighboring regions or boundaries. Each block may continue expanding unless obstructed by a collision or spatial limit. Step 460 introduces a decision point where the simulation evaluates whether any block has reached a boundary or collided with another block. If a collision is detected, and the neighboring block involved in the collision has already reached its limit for growth in that direction or has an existing “CANNOT_GO<Direction>” constraint, a corresponding “CANNOT_GO<Direction>” constraint will be applied to the colliding block to prevent further growth along that axis. However, if the neighboring block has not reached its limit or does not have the “CANNOT_GO<Direction>” constraint, both blocks may continue to expand under mutual forces. In this case, the colliding block may push the neighboring block outward until the neighboring block either reaches its spatial limit or inherits the “CANNOT_GO<Direction>” constraint, thereby propagating the directional restriction. Similarly, if a block reaches a predefined boundary, such as the edge of a solder pad or pin clearance limit, growth in that direction is halted, though expansion may continue in other directions.

The next step, 470, may evaluate whether each block has reached its target area as defined by an optimization formula. This formula may incorporate parameters such as stencil opening size, pin dimensions, and the required solder volume. If a block successfully reaches its target area, it is marked as completed and is excluded from further simulation cycles. However, if a block is fully constrained by physical boundaries and unable to expand further, it may also be marked as completed even if the target area has not been fully achieved. This ensures that the simulation remains compliant with physical and design limitations.

In one embodiment, steps 450, 460, and 470 may form an iterative loop, such that the simulation may repeat until all virtual representations have been marked as completed. Such a system may perform multiple iterations to gradually refine the layout of overprint areas while maintaining compliance with design constraints.

Once all blocks have been processed, the simulation proceeds to analyze and validate 480 the results. This analysis verifies that all overprint areas meet the required design rules, including proper spacing and solder coverage. The system checks for potential defects, such as overlapping solder paste or insufficient coverage, that could compromise manufacturing quality. After validation, the optimized design is finalized 490, and detailed output data is generated. This output includes the dimensions and coordinates of each overprint area, formatted for integration with PCB design tools. The validated data may then be saved or transferred to a manufacturing preparation system, ensuring a seamless transition from design to production.

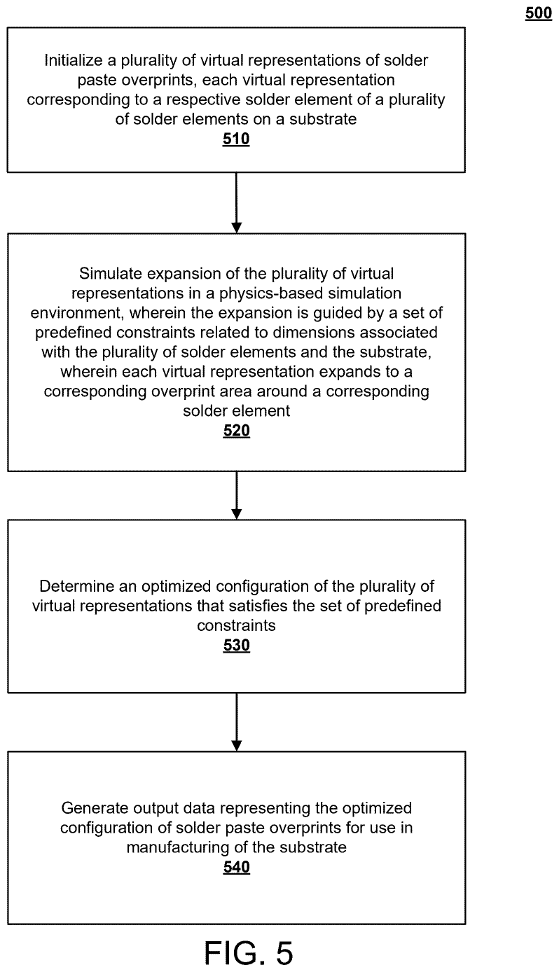

FIG. 5 illustrates an example flowchart 500 outlining an example process for optimizing solder paste overprint areas in accordance with an embodiment. The process may involve dynamically simulating and refining virtual representations of solder paste regions on a printed circuit board (PCB) to achieve a balanced and compliant configuration for manufacturing. The flowchart includes four key stages: initialization, simulation, optimization determination, and output generation.

In step 510, the process may begin by initializing a plurality of virtual representations of solder paste overprints. Each virtual representation may correspond to a solder element on the PCB, such as a pin in a through-hole. The virtual representation may be modeled as an initial geometric block or cube located at the position of the solder element. Parameters such as initial size, stencil opening area, and placement coordinates may be assigned to each representation. Additional initialization parameters may include physical properties, such as material characteristics of the solder paste, or design constraints, such as pin boundary limits. This initialization may serve as the foundation for subsequent simulation and optimization.

In step 520, the method may simulate the expansion of the virtual representations within a physics-based simulation environment. During this phase, each virtual representation may grow outward in multiple directions, simulating the spread of solder paste during manufacturing. The expansion may be influenced by predefined constraints, which may include the dimensions of the pins, hole sizes, and required spacing between adjacent solder elements. Physical interactions, such as collisions and boundary limits, may also guide the expansion process. For example, if a block reaches a pin boundary, it may stop expanding in that direction while continuing to grow in other directions where space is available. When a block expands and reaches the edge of a neighboring block, it may continue to expand and exert mutual forces that push the neighboring block outward. This process will continue until the neighboring block reaches a growth limit, which may occur when it touches a defined boundary (e.g., the pin boundary) or acquires a “CANNOT_GO<Direction>” constraint that halts further expansion in that direction. Constraints may further include minimum solder clearance (e.g., 0.25 mm) and maximum expansion limits (e.g., 5 mm from the pin boundary). The simulation environment may adjust growth rates and interactions in real-time, ensuring that the virtual representations reflect actual solder paste behavior.

In step 530, the method may determine an optimized configuration of the plurality of virtual representations. This optimization may involve evaluating whether each representation has reached a target area or stopped expanding due to spatial constraints. The optimization criteria may vary depending on design requirements but may include achieving uniform spacing, maximum solder coverage, and adherence to manufacturing tolerances. At this stage, the simulation may verify that no representation overlaps with others and that all representations collectively maintain a balanced layout across the PCB. The system may employ iterative checks to ensure that all blocks meet the target configuration or that exceptions are handled, such as marking blocks as complete when further growth is impossible.

In step 540, output data may be generated to represent the optimized configuration of solder paste overprints. This data may include the dimensions, positions, and spacing of each overprint area, formatted for integration with PCB design tools. The output may also include metadata, such as constraint information or final simulation parameters, which may be used for design verification and manufacturing setup. In some embodiments, this data may be automatically transferred to layout editing software, such as Allegro, to update the PCB design. Alternatively, the output may be stored in a data file for review or further analysis.

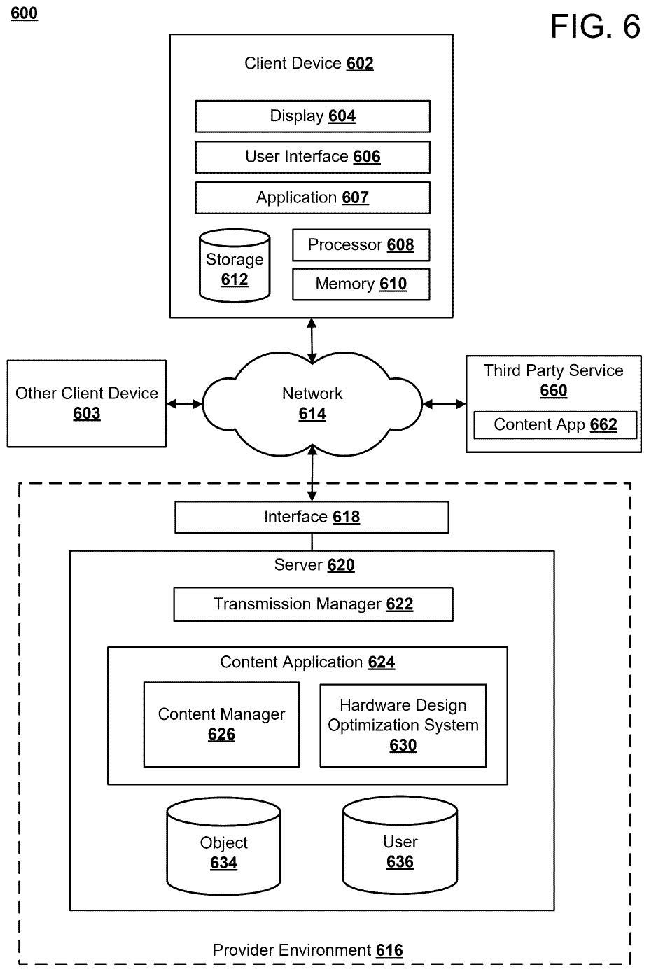

FIG. 6 illustrates an example networked system 600 that includes a hardware design optimization system, in accordance with various embodiments. The example networked system 600 can be used to provide, generate, modify, encode, process, and/or transmit data or other content. The example networked system 600 may include a client device 602, other client device 603, a network 614, a third party service 660, and a provider environment 616 that includes a hardware design optimization system 630.

The client device 602 may generate or receive data for a session using components of an application 607 on client device 602 and data stored locally on that client device 602. As an example, a user may utilize a client device 602 to optimize hardware designs using the application 607. Although only one client device 602 is illustrated in detail, the example networked system 600 may include one or more other client devices 603 that can communicate with the provider environment 616 through the network 614. A client device 602 may be any appropriate computing device capable of enabling a user to perform tasks related to optimizing hardware designs as discussed herein, such as may include a desktop computer, notebook computer, computer workstation, gaming console, set-top box, streaming device, smartphone, tablet computer, VR headset, AR goggles, wearable computer, or a smart television. In at least one embodiment, a user can access functionality related to optimizing hardware designs using a user interface (UI) 606 running on a client device 602, although at least some functionality may also operate on a remote device, networked device, or through a cloud computing platform. In at least one embodiment, a user can provide input to the UI 606, such as through a touch-sensitive display 604 or by moving a mouse cursor displayed on a display screen. In one embodiment, a user may be able to provide inputs such as preferences and configuration data to an application 607. The application 607 may be provided by the provider environment 616 for the user to download on the client device 602. In at least one embodiment, a client device can include at least one processor 608 (e.g., a CPU or GPU), a storage 612, and a memory 610 to execute application 607 and/or perform tasks on behalf of application 607.

In one embodiment, each client device 602 can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

The network 614 may represent the communication pathways among the client device 602, the provider environment 616, other client device 603, and the third party service 660. Through the network 614, the client device 602 may send input information associated with stream data processing over the network 614. The information may be received by a remote computing system, as may be part of a resource provider environment 616. In one embodiment, the network 614 is the Internet. The network 614 can include any appropriate network, including an intranet, Internet, a cellular network, a local area network (LAN), or any other such network or combination, and communication over a network can be enabled via wired and/or wireless connections. The network 614 can also utilize dedicated or private communication links that are not necessarily part of the Internet. In one embodiment, the network 614 uses standard communications technologies and/or protocols. Thus, the network 614 can include links using technologies such as Ethernet, Wi-Fi, integrated services digital network (ISDN), digital subscriber lines (DSL), asynchronous transfer mode (ATM), etc. Similarly, the networking protocols used on the network 614 can include multiprotocol label switching (MPLS), the transmission control protocol/Internet protocol (TCP/IP), the hypertext transport protocol (HTTP), the simple mail transfer protocol (SMTP), the file transfer protocol (FTP), etc. In one embodiment, at least some of the links use mobile networking technologies, such as long term evolution (LTE). The data exchanged over the network 614 can be represented using technologies or formats including the hypertext markup language (XML), the wireless access protocol (WAP), the short message service (SMS) etc. In addition, all or some of the links can be encrypted using conventional encryption technologies such as the secure sockets layer (SSL), secure HTTP or virtual private networks (VPNs). In another embodiment, the client device 602 can use custom and/or dedicated data communications technologies instead of, or in addition to, the ones described above.

The provider environment 616 may include any appropriate components for receiving requests and returning information or performing actions in response to those requests. In the embodiment illustrated in FIG. 6, the provider environment 616 may include an interface 618, and a server 620 that include various components for performing tasks associated with optimizing hardware designs. In at least one embodiment, the provider environment 616 might include Web servers and/or application servers for receiving and processing requests, then returning data or other content or information in response to a request.

The interface 618 may receive communications to the server 620. In at least one embodiment, the interface 618 can include application programming interfaces (APIs) or other exposed interfaces enabling a user to submit requests to the server 620. In at least one embodiment, the interface 618 can include other components as well, such as at least one Web server, routing components, or load balancers. In at least one embodiment, components of an interface 618 can determine a type of request or communication, and can direct a request to an appropriate system or service such as a hardware design optimization system 630.

The server 620 may include a transmission manager 622, a content application 624, an object repository 634, and a user database 636. The server 620 may receive requests and data from the client device 602, perform tasks associated with the requests, and send results or other data to the client device 602. In at least one embodiment, a content application 624 executing on the server 620 (e.g., a cloud server or edge server) may initiate a session associated with the client device 602, as may use a session manager and user data stored in a user database 636, and can cause content such as one or more object representations from an object repository 634 to be selected by a content manager 626 for processing. At least a portion of the generated content, such as results from stream data processing may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding application 607 for selecting, providing, synthesizing, modifying, or using content for presentation (or other purposes) on or by the client device 602. A decoder may also be used to decode data received over the network 614 for presentation via client device 602, such as image or video content through a touch-sensitive display 604. In at least one embodiment, at least some of the content may already be stored on, rendered on, or accessible to client device 602 such that transmission over the network 614 is not required for at least that portion of content, such as where the content may have been previously downloaded or stored locally on a hard drive or optical disk. In at least one embodiment, a transmission mechanism such as data streaming can be used to transfer the content from the server 620, or user database 636, to client device 602. In at least one embodiment, at least a portion of this content can be obtained, enhanced, and/or streamed from another source, such as a third party service 660 or other client device 603, that may also include a content application 662 for generating, enhancing, or providing content. In at least one embodiment, portions of this functionality can be performed using multiple computing devices, or multiple processors within one or more computing devices, such as may include a combination of CPUs and GPUs.

In at least one embodiment, the server 620 may include a processor such as a central processing unit (CPU). In at least one embodiment, however, resources in such environments can utilize GPUs to process data for at least certain types of requests. In at least one embodiment, with thousands of cores, GPUs are designed to handle substantial parallel workloads and, therefore, have become popular in deep learning for training neural networks and generating predictions. In at least one embodiment, while use of GPUs for offline builds has enabled faster training of larger and more complex models, generating predictions offline implies that either request-time input features cannot be used or predictions must be generated for all permutations of features and stored in a lookup table to serve real-time requests. In at least one embodiment, if a deep learning framework supports a CPU-mode and a model is small and simple enough to perform a feed-forward on a CPU with a reasonable latency, then a service on a CPU instance could host a model. In at least one embodiment, training can be done offline on a GPU and inference done in real-time on a CPU. In at least one embodiment, if a CPU approach is not a viable option, then a service can run on a GPU instance. In at least one embodiment, because GPUs have different performance and cost characteristics than CPUs, however, running a service that offloads a runtime algorithm to a GPU can require it to be designed differently from a CPU based service.

The server 620 may include a content application 624 that includes a content manager 626 and a hardware design optimization system 630. As discussed previously, the content manager 626 may send objects, such as datasets and instructions, from the object repository 634 along with requests and other data from the client device 602 to a hardware design optimization system 630 for stream data processing. A hardware design optimization system 630 may process input data and provide the results to the transmission manager 622 for sending back to the client device 602. A hardware design optimization system 630 may also use local datasets or datasets provided by the third party service 660 for stream data processing.

### Inference and Training Logic

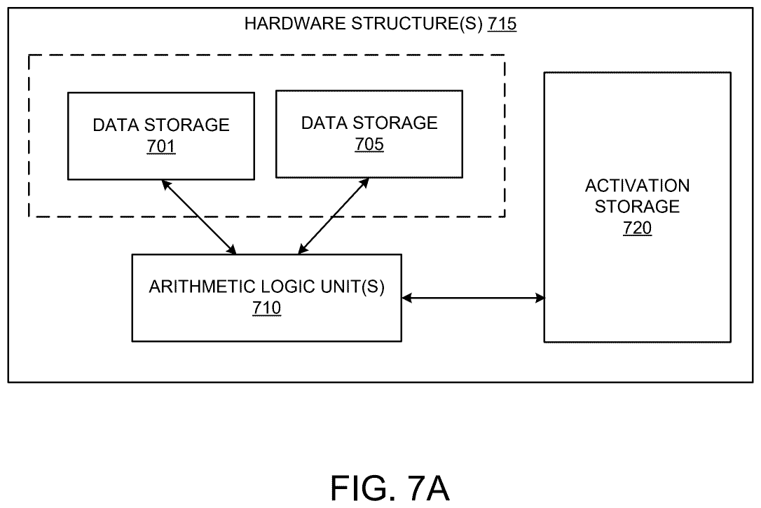

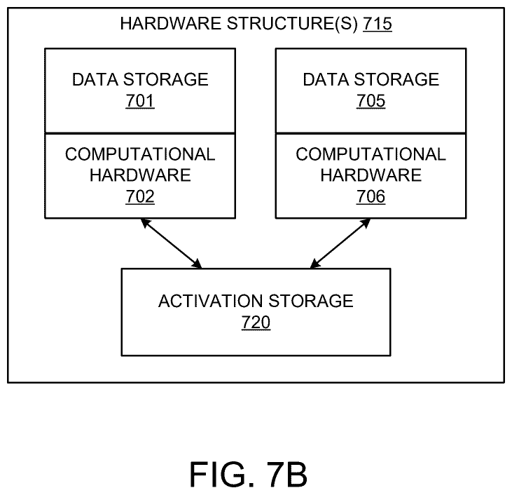

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

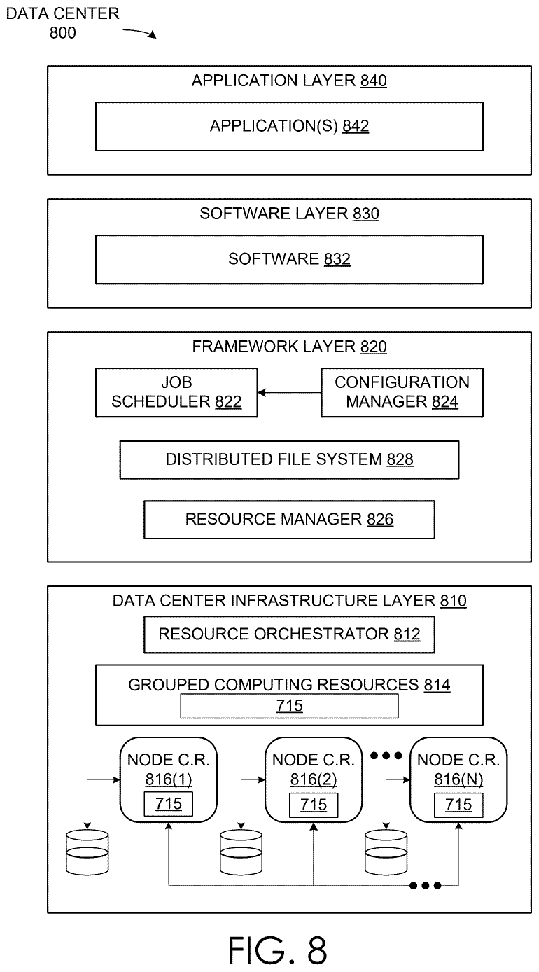

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can allow for multi-frame interpolation for improved user experience.

### Computer Systems

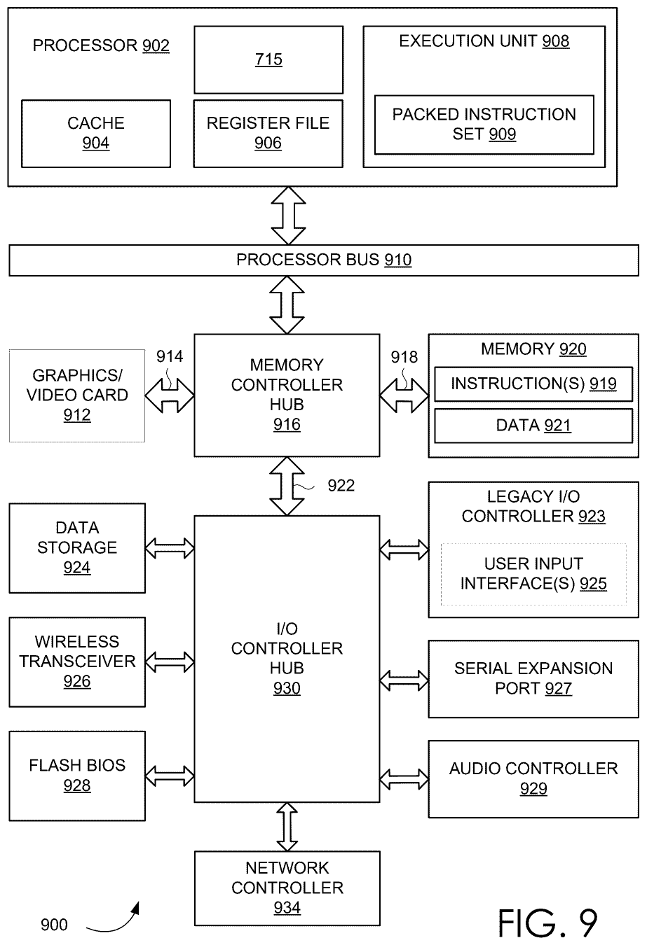

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can allow for optimizing hardware designs for improved user experience.

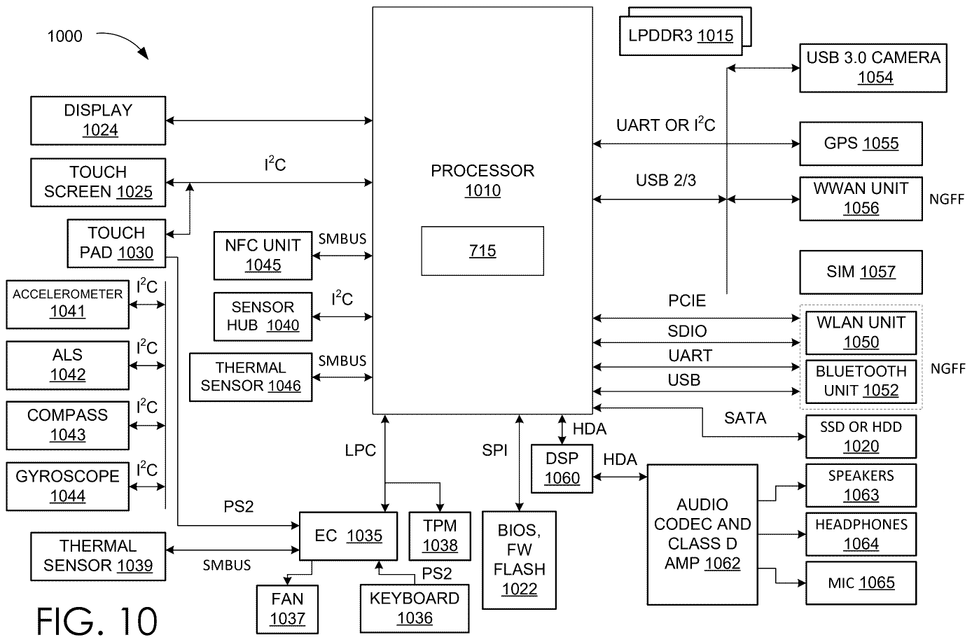

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can allow for optimizing hardware designs for improved user experience.

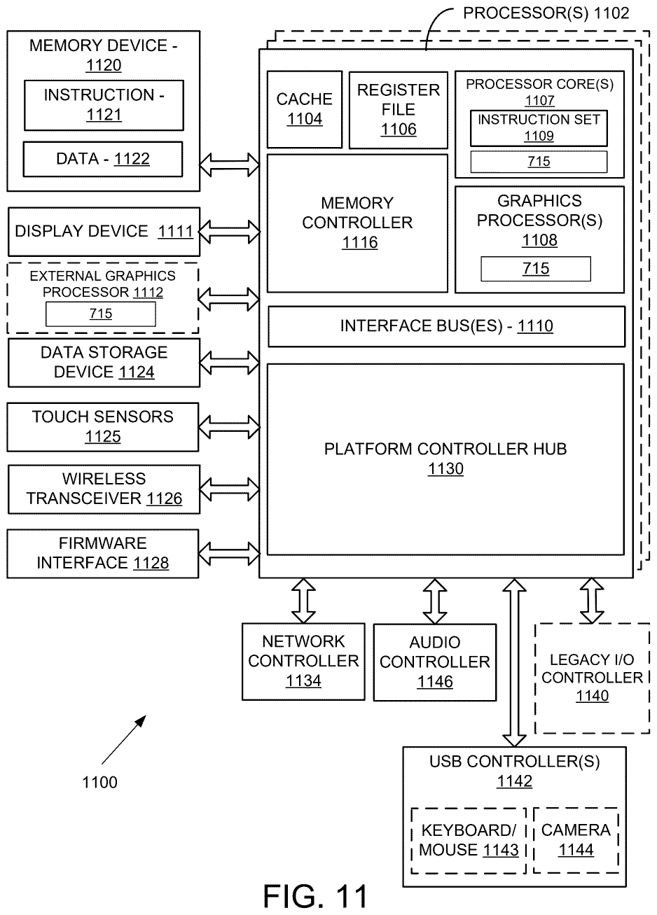

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can allow for optimizing hardware designs for improved user experience.

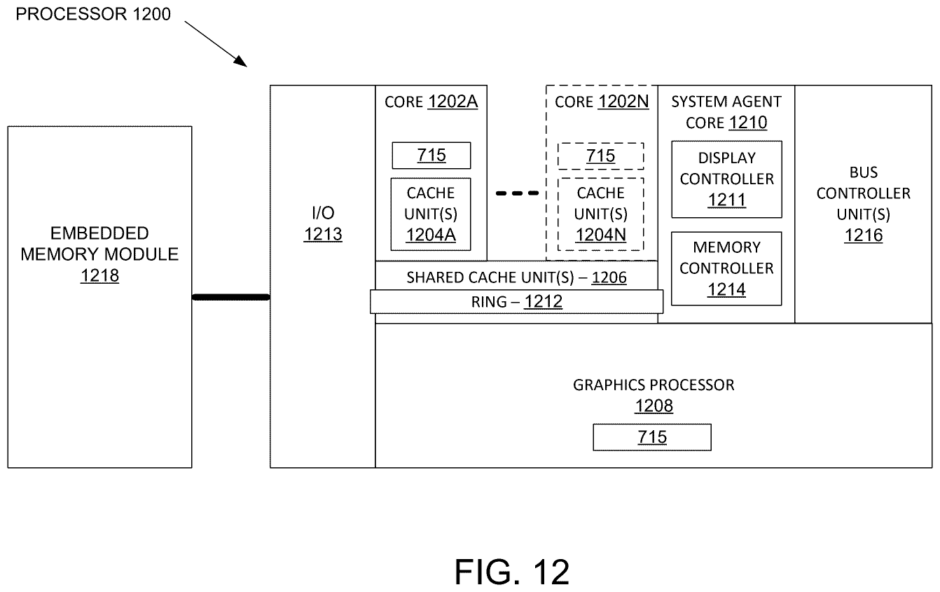

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can allow for optimizing hardware designs for improved user experience.

### Virtualized Computing Platform

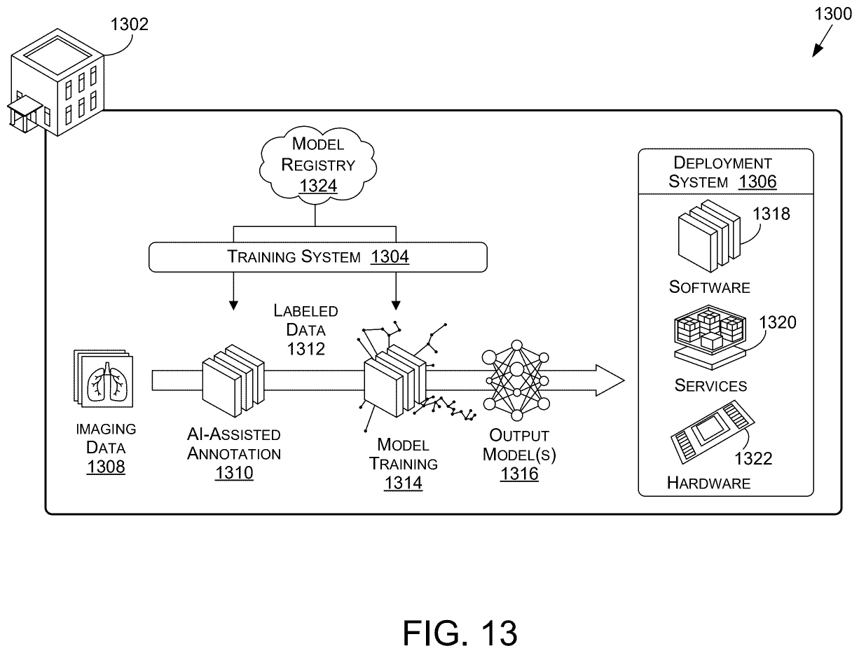

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

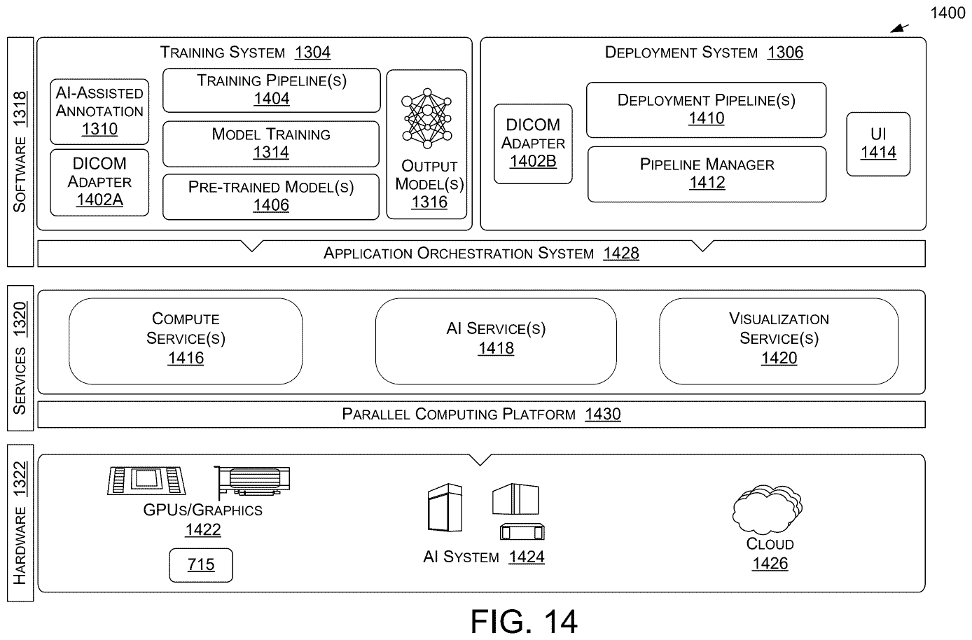

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 14301230 (FIG. 14)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322 deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

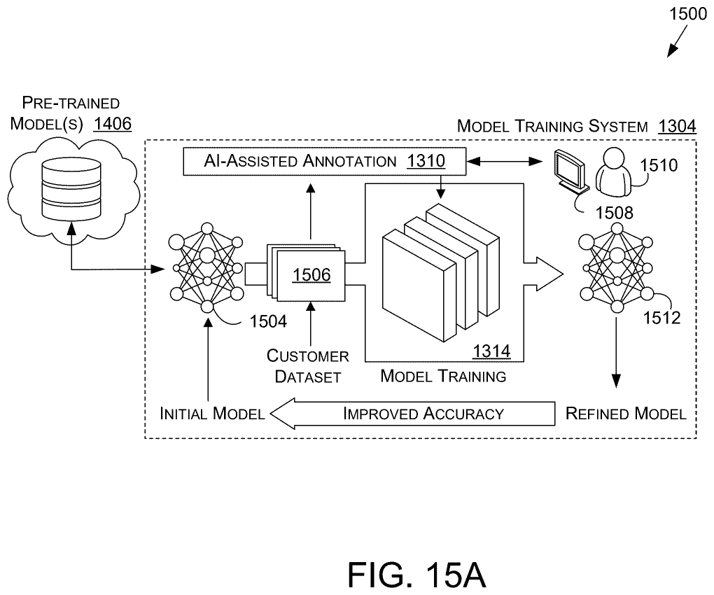

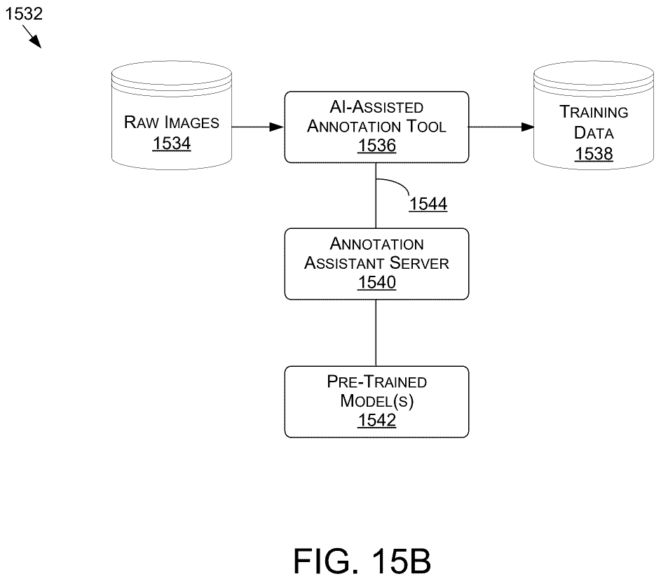

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new dataset based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public dataset, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Such components can allow for optimizing hardware designs for improved user experience.

Various embodiments can be described by the following clauses:
1. A computer-implemented method, comprising:
   initializing a plurality of virtual representations of solder paste overprints, one or more virtual representations of the plurality of virtual representations corresponding to a respective solder element of a plurality of solder elements on a substrate;
   simulating expansion of the plurality of virtual representations in a physics-based simulation environment, wherein the expansion is guided by a set of predefined constraints related to one or more dimensions associated with the plurality of solder elements and the substrate, wherein each of the one or more virtual representations expands to a corresponding overprint area around a corresponding solder element;
   determining an optimized configuration of the plurality of virtual representations that satisfies the set of predefined constraints; and
   generating output data representing the optimized configuration of solder paste overprints.
2. The computer-implemented method of clause 1, wherein simulating the expansion of the plurality of virtual representations further comprises:
   controlling the expansion wherein each of the one or more virtual representations expands uniformly at a same rate along each direction in a two-dimensional plane.
3. The computer-implemented method of clause 1, wherein simulating the expansion of the plurality of virtual representations further comprises:
   detecting a collision between at least two adjacent virtual representations during the expansion;
   constraining further expansion of at least one of the two virtual representations involved in the collision; and
   redistributing available space among the plurality of virtual representations in response to the collision to achieve the optimized configuration.
4. The computer-implemented method of clause 1, wherein each of the one or more virtual representations is associated with a predefined goal area, and wherein the simulating further comprises:
   monitoring sizes associated with the plurality of virtual representations during the expansion;
   halting the expansion of at least one virtual representation in response to the at least one virtual representation reaching the predefined goal area; and
   recording a status associated with the at least one virtual representation as completed.
5. The computer-implemented method of clause 1, wherein the substrate corresponds to one or more thicknesses, and the optimized configuration is determined based on a specific thickness associated with the substrate.
6. The computer-implemented method of clause 1, further comprising:
   determining additional optimized configurations of solder paste overprints for each thickness of a plurality of thicknesses; and
   generating output data representing the additional optimized configurations of solder paste overprints for use in manufacturing of the substrate.
7. The computer-implemented method of clause 1, wherein the set of predefined constraints includes a minimum allowable distance between adjacent solder paste overprints and a maximum allowable distance from at least one solder element to a corresponding overprint area boundary.
8. The computer-implemented method of clause 1, further comprising adjusting a set of parameters associated with the simulation in the physics-based simulation environment, the set of parameters including one or more of: a max de-penetration, one or more rigid body properties, one or more friction coefficients, one or more collision offsets, or a growth velocity.
9. The computer-implemented method of clause 1, further comprising:
   storing the optimized configuration of solder paste overprints in a cloud-based database, wherein the optimized configuration is associated with one or more corresponding parameters, including at least one of: a substrate design, a substrate thickness, one or more solder element dimensions, or one or more predefined constraints; and
   in response to receiving a request with one or more parameters matching the one or more corresponding parameters, retrieving the stored optimized configuration for subsequent substrate designs.
10. At least one processor comprising:
   one or more processing units to:
   initialize a plurality of virtual representations of solder paste overprints, one or more virtual representations of the plurality of virtual representations corresponding to a respective solder element of a plurality of solder elements on a substrate;
   simulate expansion of the plurality of virtual representations in a physics-based simulation environment, wherein the expansion is guided by a set of predefined constraints related to dimensions associated with the plurality of solder elements and the substrate, wherein each of the one or more virtual representations expands to a corresponding overprint area around a corresponding solder element;
   determine an optimized configuration of the plurality of virtual representations that satisfies the set of predefined constraints; and
   generate output data representing the optimized configuration of solder paste overprints.
11. The processor of clause 10, wherein the one or more processing units are further to:
   control the expansion wherein each of the one or more virtual representations expands uniformly at a same rate along at least one direction in a two-dimensional plane.
12. The processor of clause 10, wherein the one or more processing units are further to:
   detect a collision between at least two virtual representations during the expansion;
   constrain further expansion of at least one of the at least two virtual representations involved in the collision; and
   redistribute available space among the plurality of virtual representations in response to the collision to achieve the optimized configuration.
13. The processor of clause 10, wherein each of the one or more virtual representations is associated with a predefined goal area, and wherein the simulating further comprises:
   one or more monitor sizes associated with the plurality of virtual representations during the expansion;
   halt the expansion of a virtual representation in response to the virtual representation reaching the predefined goal area; and
   record a status associated with the virtual representation as completed.
14. The processor of clause 10, wherein the substrate corresponds to one or more thicknesses, and the optimized configuration is determined based on a specific thickness associated with the substrate.
15. The processor of clause 10, wherein the processor is included in a system comprising at least one of:
   a system for performing simulation operations;
   a system for performing simulation operations to test or validate autonomous machine applications;
   a system for performing digital twin operations;
   a system for performing light transport simulation;
   a system for rendering graphical output;
   a system for performing deep learning operations;
   a system implemented using an edge device;
   a system for generating or presenting virtual reality (VR) content;
   a system for generating or presenting augmented reality (AR) content;
   a system for generating or presenting mixed reality (MR) content;
   a system incorporating one or more Virtual Machines (VMs);
   a system implemented at least partially in a data center;
   a system for performing hardware testing using simulation;
   a system for synthetic data generation;
   a system for performing generative AI operations;
   a system implemented using one or more small language model (SLMs);
   a system implemented using one or more large language model (LLMs);
   a system implemented using one or more vision language model (VLMs);
   a system implemented using one or more multi-modal language model (MMLMs);
   a system using or deploying one or more inference microservices;
   a system that incorporates one or more machine learning models deployed in a service or microservice along with an OS-level virtualization package (e.g., a container);
   a collaborative content creation platform for 3D assets; or
   a system implemented at least partially using cloud computing resources.
16. A system, comprising:
   one or more processing units to determine an optimized configuration of a plurality of virtual representations of solder paste overprints, one or more virtual representations of the plurality of virtual representations corresponding to a respective solder element of a plurality of solder elements on a substrate, wherein the optimized configuration is determined based on a simulation of expansion of the plurality of virtual representations in a physics-based simulation environment, the expansion guided by a set of predefined constraints, wherein each of the one or more virtual representation expands to a corresponding overprint area around a corresponding solder element.
17. The system of clause 16, wherein the one or more processing units are further to:
   detect a collision between at least two virtual representations during the expansion;
   constrain further expansion of at least one virtual representation of the at least two virtual representations involved in the collision; and
   redistribute available space among the plurality of virtual representations in response to the collision to achieve the optimized configuration.
18. The system of clause 16, wherein the substrate corresponds to one or more thicknesses, and the optimized configuration is determined based on a specific thickness associated with the substrate.
19. The system of clause 16, wherein the one or more processing units are further to:
   determine additional optimized configurations of solder paste overprints for each thickness of a plurality of thicknesses; and
   generate output data representing the additional optimized configurations of solder paste overprints for use in manufacturing of the substrate.
20. The system of clause 16, wherein the one or more processing units are further to adjust a set of parameters associated with the simulation in the physics-based simulation environment, the set of parameters including one or more of: a max de-penetration, one or more rigid body properties, one or more friction coefficients, one or more collision offsets, or a growth velocity.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or example language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as example forms of implementing the claims.

What is claimed is:

1. A computer-implemented method, comprising:
initializing a plurality of virtual representations of solder paste overprints, one or more virtual representations of the plurality of virtual representations corresponding to a respective solder element of a plurality of solder elements on a substrate;
simulating expansion of the plurality of virtual representations in a physics-based simulation environment, wherein the expansion is guided by a set of predefined constraints related to one or more dimensions associated with the plurality of solder elements and the substrate, wherein each of the one or more virtual representations expands to a corresponding overprint area around a corresponding solder element;
determining an optimized configuration of the plurality of virtual representations that satisfies the set of predefined constraints; and
generating output data representing the optimized configuration of solder paste overprints.

2. The computer-implemented method of claim 1, wherein simulating the expansion of the plurality of virtual representations further comprises:
controlling the expansion wherein each of the one or more virtual representations expands uniformly at a same rate along each direction in a two-dimensional plane.

3. The computer-implemented method of claim 1, wherein simulating the expansion of the plurality of virtual representations further comprises:
detecting a collision between at least two adjacent virtual representations during the expansion;
constraining further expansion of at least one of the two virtual representations involved in the collision; and
redistributing available space among the plurality of virtual representations in response to the collision to achieve the optimized configuration.

4. The computer-implemented method of claim 1, wherein each of the one or more virtual representations is associated with a predefined goal area, and wherein the simulating further comprises:
monitoring sizes associated with the plurality of virtual representations during the expansion;
halting the expansion of at least one virtual representation in response to the at least one virtual representation reaching the predefined goal area; and
recording a status associated with the at least one virtual representation as completed.

5. The computer-implemented method of claim 1, wherein the substrate corresponds to one or more thicknesses, and the optimized configuration is determined based on a specific thickness associated with the substrate.

6. The computer-implemented method of claim 1, further comprising:
determining additional optimized configurations of solder paste overprints for each thickness of a plurality of thicknesses; and
generating output data representing the additional optimized configurations of solder paste overprints for use in manufacturing of the substrate.

7. The computer-implemented method of claim 1, wherein the set of predefined constraints includes a minimum allowable distance between adjacent solder paste overprints and a maximum allowable distance from at least one solder element to a corresponding overprint area boundary.

8. The computer-implemented method of claim 1, further comprising adjusting a set of parameters associated with the simulation in the physics-based simulation environment, the set of parameters including one or more of: a max de-penetration, one or more rigid body properties, one or more friction coefficients, one or more collision offsets, or a growth velocity.

9. The computer-implemented method of claim 1, further comprising:
storing the optimized configuration of solder paste overprints in a cloud-based database, wherein the optimized configuration is associated with one or more corresponding parameters, including at least one of: a substrate design, a substrate thickness, one or more solder element dimensions, or one or more predefined constraints; and
in response to receiving a request with one or more parameters matching the one or more corresponding parameters, retrieving the stored optimized configuration for subsequent substrate designs.

10. At least one processor comprising:
one or more processing units to:
initialize a plurality of virtual representations of solder paste overprints, one or more virtual representations of the plurality of virtual representations corresponding to a respective solder element of a plurality of solder elements on a substrate;
simulate expansion of the plurality of virtual representations in a physics-based simulation environment, wherein the expansion is guided by a set of predefined constraints related to dimensions associated with the plurality of solder elements and the substrate, wherein each of the one or more virtual representations expands to a corresponding overprint area around a corresponding solder element;
determine an optimized configuration of the plurality of virtual representations that satisfies the set of predefined constraints; and
generate output data representing the optimized configuration of solder paste overprints.

11. The processor of claim 10, wherein the one or more processing units are further to:
control the expansion wherein each of the one or more virtual representations expands uniformly at a same rate along at least one direction in a two-dimensional plane.

12. The processor of claim 10, wherein the one or more processing units are further to:
detect a collision between at least two virtual representations during the expansion;
constrain further expansion of at least one of the at least two virtual representations involved in the collision; and
redistribute available space among the plurality of virtual representations in response to the collision to achieve the optimized configuration.

13. The processor of claim 10, wherein each of the one or more virtual representations is associated with a predefined goal area, and wherein the simulating further comprises:
one or more monitor sizes associated with the plurality of virtual representations during the expansion;
halt the expansion of a virtual representation in response to the virtual representation reaching the predefined goal area; and
record a status associated with the virtual representation as completed.

14. The processor of claim 10, wherein the substrate corresponds to one or more thicknesses, and the optimized configuration is determined based on a specific thickness associated with the substrate.

15. The processor of claim 10, wherein the processor is included in a system comprising at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more small language model (SLMs);
a system implemented using one or more large language model (LLMs);
a system implemented using one or more vision language model (VLMs);
a system implemented using one or more multi-modal language model (MMLMs);
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

16. A system, comprising:
one or more processing units to determine an optimized configuration of a plurality of virtual representations of solder paste overprints, one or more virtual representations of the plurality of virtual representations corresponding to a respective solder element of a plurality of solder elements on a substrate, wherein the optimized configuration is determined based on a simulation of expansion of the plurality of virtual representations in a physics-based simulation environment, the expansion guided by a set of predefined constraints, wherein each of the one or more virtual representation expands to a corresponding overprint area around a corresponding solder element.

17. The system of claim 16, wherein the one or more processing units are further to:
detect a collision between at least two virtual representations during the expansion;
constrain further expansion of at least one virtual representation of the at least two virtual representations involved in the collision; and
redistribute available space among the plurality of virtual representations in response to the collision to achieve the optimized configuration.

18. The system of claim 16, wherein the substrate corresponds to one or more thicknesses, and the optimized configuration is determined based on a specific thickness associated with the substrate.

19. The system of claim 16, wherein the one or more processing units are further to:
determine additional optimized configurations of solder paste overprints for each thickness of a plurality of thicknesses; and
generate output data representing the additional optimized configurations of solder paste overprints for use in manufacturing of the substrate.

20. The system of claim 16, wherein the one or more processing units are further to adjust a set of parameters associated with the simulation in the physics-based simulation environment, the set of parameters including one or more of: a max de-penetration, one or more rigid body properties, one or more friction coefficients, one or more collision offsets, or a growth velocity.
